(19) United States
(12) Patent Application Publication
(10) Pub. No.: US 2016/0080826 A1
(43) Pub. Date: Mar. 17, 2016

(54) SYSTEMS, METHODS AND APPARATUS FOR BROADCASTING PAY-PER-VIEW VIDEO OVER ENHANCED MULTIMEDIA BROADCAST MULTICAST SERVICE

(71) Applicant: QUALCOMM Incorporated, San Diego, CA (US)

(72) Inventors: Sandip Kumar Sarkar, San Diego, CA (US); Khalid Mutasem Elsayyed Barghouti, Dubai (AE)

(21) Appl. No.: 14/487,547

(22) Filed: Sep. 16, 2014

(51) Int. Cl. H04N 21/6375; H04L 29/06; H04H 20/72; H04N 21/414; H04N 21/61; H04H 20/57; H04W 72/00; H04W 72/04

(52) U.S. Cl. CPC H04N 21/6375; H04W 72/005; H04L 65/4084; H04W 72/0413; H04L 65/602; H04N 21/41407; H04N 21/6131; H04H 20/57; H04H 20/72; H04L 65/80

(57) ABSTRACT

Systems, methods and apparatus for broadcasting PPV video over eMBMS are provided. In one aspect, an apparatus for wireless communication comprises a receiver configured to receive a plurality of segments of a multimedia data transmission. The apparatus further comprises a processor configured to determine missing or corrupted segments of the plurality of segments. The apparatus further comprises a transmitter configured to transmit a request to receive the missing or corrupted segments during a timeframe when data traffic is below a predetermined threshold. Each of the plurality of segments is encoded with a serial number. The processor is configured to determine the missing or corrupted segments based at least in part on the serial number of one or more of the plurality of segments. The receiver is configured to receive an enhancement layer transmission providing multimedia data having a higher quality than a quality of the plurality of segments.

### BACKGROUND

1. Field

Certain aspects of the present disclosure generally relate to wireless communications, and more particularly, to systems, apparatus and methods for broadcasting pay-per-view (PPV) video over enhanced multimedia broadcast multicast (eMBMS).

2. Background

Some long term evolution (LTE) service providers are interested in allowing subscribers to download movies and PPV programs to a mobile device or set top box. These operators intend to use eMBMS to broadcast the data for these PPV programs to the mobile devices or set top boxes of various subscribers for storage at those subscribers' devices. However, because LTE signals are generally weakest within the subscribers' homes where the devices or set top boxes are generally located, when packets are lost or received in a corrupted state, program quality may be unacceptably reduced. Conventional LTE broadcasting (e.g., addressing and transmitting the data to all or several users at a time) usually does not support the retransmission of corrupted data on a per user basis. Thus, users may experience a “blip” or video dropout during playback when the PPV videos are broadcast via LTE and certain portions of the PPV program are not received or are received in a corrupted state. Accordingly, systems, apparatus and methods for broadcasting PPV video over eMBMS are desirable.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides an apparatus for wireless communication. The apparatus comprises a receiver configured to receive a plurality of segments of a multimedia data transmission. The apparatus comprises a processor configured to determine missing or corrupted segments of the plurality of segments. The apparatus comprises a transmitter configured to transmit a request to receive the missing or corrupted segments during a timeframe when data traffic is below a predetermined threshold.

Another aspect of the disclosure provides a method for wireless communication. The method comprises receiving a plurality of segments of a multimedia data transmission. The method comprises determining missing or corrupted segments of the plurality of segments. The method comprises transmitting a request to receive the missing or corrupted segments during a timeframe when data traffic is below a predetermined threshold.

Another aspect of the disclosure provides an apparatus for wireless communication. The method comprises means for receiving a plurality of segments of a multimedia data transmission. The apparatus comprises means for determining missing or corrupted segments of the plurality of segments. The apparatus comprises means for transmitting a request to receive the missing or corrupted segments during a timeframe when data traffic is below a predetermined threshold.

Another aspect of the disclosure provides a non-transitory computer-readable medium comprising code. The code, when executed, causes a device to receive a plurality of segments of a multimedia data transmission. The code, when executed, further causes the device to determine missing or corrupted segments of the plurality of segments. The code, when executed, further causes the device to transmit a request to receive the missing or corrupted segments during a timeframe when data traffic is below a predetermined threshold.

### BRIEF DESCRIPTION OF THE DRAWINGS

FIG. 1 illustrates an example of a communication system in which aspects of the present disclosure may be employed.

FIG. 2 illustrates various components that may be utilized in a device that may be employed within the communication system of FIG. 1.

FIG. 3 illustrates an exemplary exchange of a plurality of packets between a source device and the communication device of FIG. 2, in accordance with one implementation.

FIG. 4 is exemplary timeline depicting a network data traffic level associated with the communication device of FIG. 2, in accordance with one implementation.

FIG. 5 is a flow chart for a method of communication, in accordance with one implementation.

FIG. 6 is a functional block diagram of an exemplary device for communicating, in accordance with one implementation.

### DETAILED DESCRIPTION

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, access networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless access network technologies may include various types of wireless local area access networks (WLANs). A WLAN may be used to interconnect nearby devices together, employing widely used access networking protocols. The various aspects described herein may apply to any communication standard, such as Wi-Fi or, more generally, any member of the IEEE 802.11 family of wireless protocols.

In some implementations, a WLAN includes various devices which are the components that access the wireless access network. For example, there may be two types of devices: access points (“APs”) and clients (also referred to as stations, or “STAs”). In general, an AP serves as a hub or base station for the WLAN and an STA serves as a user of the WLAN. For example, a STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area access networks. In some implementations an STA may also be used as an AP.

An access point (“AP”) may comprise, be implemented as, or known as a NodeB, Radio Access network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A station (“STA”) may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

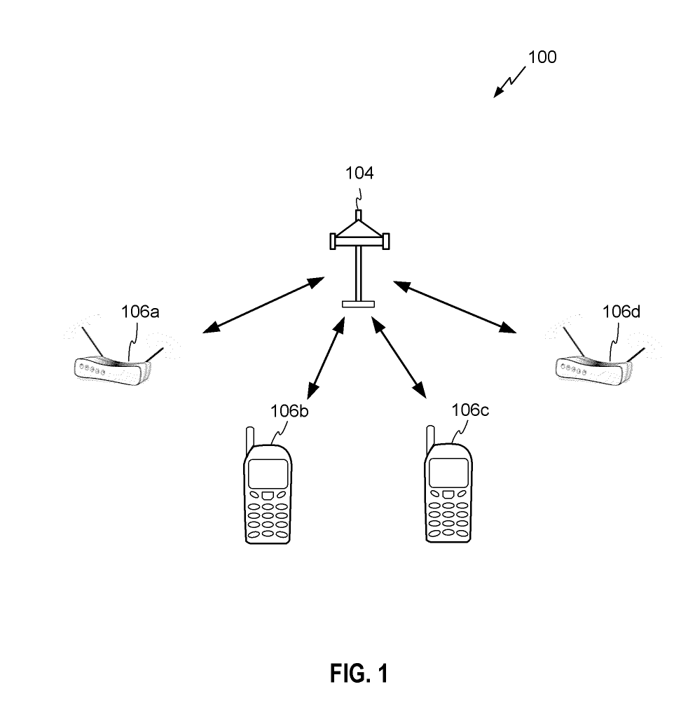

FIG. 1 illustrates an example of a communication system in which aspects of the present disclosure may be employed. At least a portion of the communication system 100 may operate pursuant to a wireless standard (e.g., 4G LTE). The communication system 100 may include an AP 104 and a plurality of STAs 106a, 106b, 106c, 106d (hereinafter STAs 106a-106d). The STAs 106a-106d may comprise mobile wireless devices, laptops, PDAs, set top video boxes or any other devices configured to receive and display video from a source (e.g., through the AP 104) over a cellular access network connection (e.g., a 4G LTE connection). A communication from any one of the STAs 106a-106d to the AP 104 may be considered an uplink transmission, while a communication from the AP 104 to any of the STAs 106a-106d may comprise a downlink transmission. Where the AP 104 simultaneously intentionally transmits one or more data packets to more than one of the STAs 106a-106d, the transmission may be a broadcast transmission.

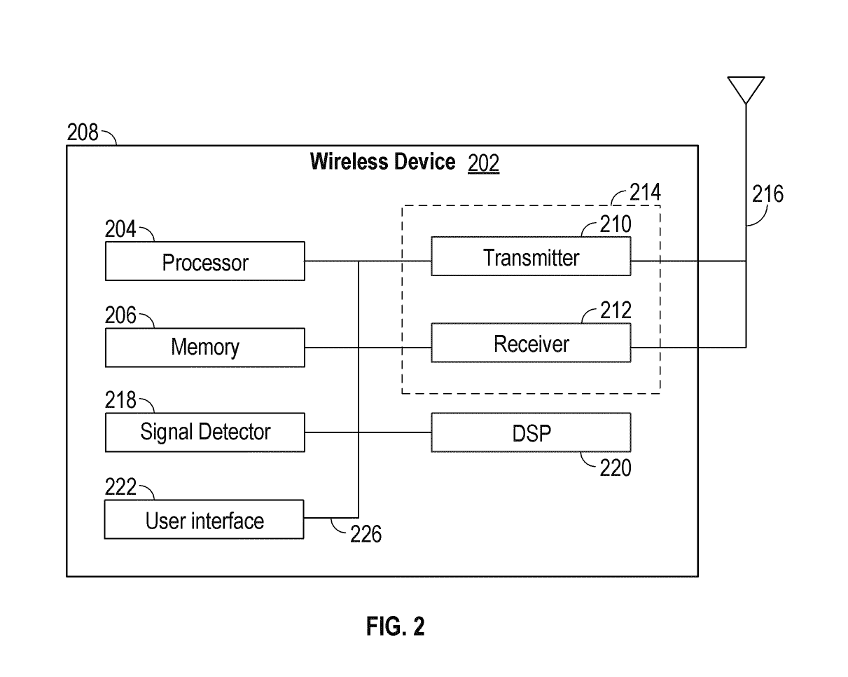

FIG. 2 illustrates various components that may be utilized in a device that may be employed within the communication system of FIG. 1. The device 202 may be a wireless device for example, but the present application is not so limited. The device 202 is an example of a device that may be configured to implement the various methods described herein. The device 202 may comprise any of the STAs 106a-106d and the AP 104.

The device 202 may include a processor 204 which controls operation of the device 202. The processor 204 may also be referred to as a central processing unit (CPU) or hardware processor. Memory 206, which may include both read-only memory (ROM) and random access memory (RAM), may provide instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The processor 204 may comprise or be a component of a processing system implemented with one or more processors. Thus, where one or more operations are performed by the processor 204, the operations may be performed by a single processor 204, or alternatively a subset of the operations may each be performed by respective separate processors, which in combination form the processor 204. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include transitory or non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The device 202 may also include a housing 208 that may include a transmitter 210 and a receiver 212 to allow transmission and reception of data between the device 202 and a remote location. The transmitter 210 and receiver 212 may be combined into a transceiver 214. An antenna 216 may be attached to the housing 208 and electrically coupled to the transceiver 214. The device 202 may also include (not shown) multiple transmitters, multiple receivers, multiple transceivers, and/or multiple antennas, which may be utilized during MIMO communications, for example.

The device 202 may also include a signal detector 218 that may be used in an effort to detect and quantify the level of signals received by the transceiver 214. The signal detector 218 may detect such signals as total energy, energy per subcarrier per symbol, power spectral density and other signals. The device 202 may also include a digital signal processor (DSP) 220 for use in processing signals. The DSP 220 may be configured to generate a data unit for transmission.

The device 202 may further comprise a user interface 222 in some aspects. The user interface 222 may comprise a keypad, a microphone, a speaker, and/or a display. The user interface 222 may include any element or component that conveys information to a user of the device 202 and/or receives input from the user.

The various components of the device 202 may be coupled together by a bus system 226. The bus system 226 may include a data bus, for example, as well as a power bus, a control signal bus, and a status signal bus in addition to the data bus. Those of skill in the art will appreciate the components of the device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

The communications exchanged between devices in a wireless network may include data units which may comprise packets or frames. In some aspects, the data units may include data frames, control frames, and/or management frames. Data frames may be used for transmitting data from a BS, AP and/or a STA to other BSs, APs and/or STAs. Control frames may be used together with data frames for performing various operations and for reliably delivering data (e.g., acknowledging receipt of data, polling of BSs, area-clearing operations, channel acquisition, carrier-sensing maintenance functions, etc.). Management frames may be used for various supervisory functions (e.g., for joining and departing from wireless networks, etc.).

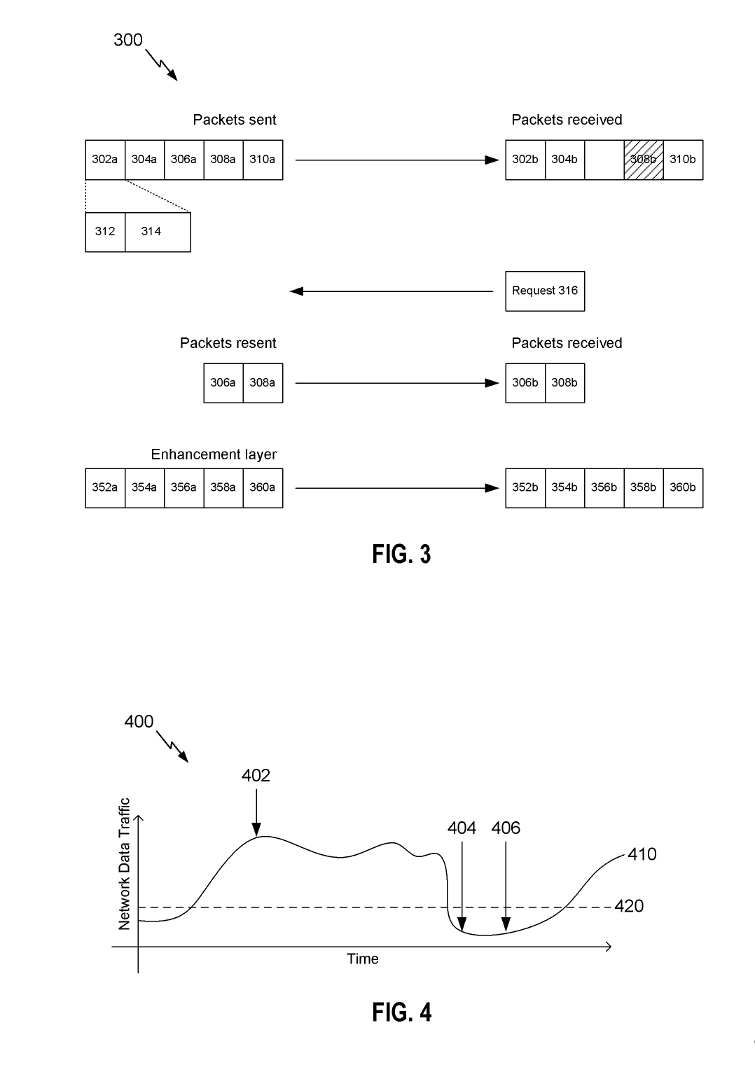

FIG. 3 illustrates an exemplary exchange of a plurality of packets between a source device and the communication device of FIG. 2, in accordance with one implementation. As show in FIG. 3, a multimedia data transmission (e.g., a pay per view movie or television program) may be divided into a plurality of segments 302a, 304a, 306a, 308a, 310a (hereinafter collectively 302a-310a). Each of the segments 302a-310a may include a serial number 312 as well as a data portion 314. In some implementations, a length of the segments 302a-310a may be dynamically varied in order to optimize an overhead requirement for the multimedia data transmission. For example, where connection quality or channel signal to noise ratios (SNR) are above a particular threshold, the segments 302a-310a may be longer than where connection quality or channel SNR is below the threshold. In such implementations, the data portions 314 may be increased in length. Where the connection quality rises above the threshold during transmission one or more of the plurality of received segments 302a-310a may have a different length than one or more other of the plurality of received segments 302a-310a. Each of the packets 302a-310a may be transmitted (e.g., via an LTE broadcast utilizing eMBMS by the AP 104 of FIG. 1) to one or more sink devices (e.g., the STAs 106a-106d of FIG. 1) which may comprise mobile devices, cable set top boxes, or any other device configured to receive and store multimedia data transmissions for display at a later time.

As shown, each of the transmitted packets 302a, 304a and 310a may be correctly received at the sink device as received packets 302b, 304b, and 310b. However, sent packet 306a may not be received at the sink device, and sent packet 308a may be received as a corrupted received packet 308b. In some implementations, the sink device may determine which segments are missing or corrupted based at least in part on the serial number of one or more of the plurality of segments. For example, a processor within the sink device (e.g., the processor 204 of the wireless device 202 in FIG. 2) may read the serial numbers in one or more of the received packets 302b, 304b, and 310b and determine that the sent packet 306a was not received and that the sent packet 308a was received in a corrupted state, as received packet 308b.

In response, the sink device may generate and transmit a request 316 to the source device (e.g., the AP 104 of FIG. 1) requesting that the missing or corrupted segments be transmitted during a later timeframe when data traffic is below a predetermined threshold (e.g., during an off-peak timeframe). The request 316 may be transmitted by one or more of the STAs 106a-106d via an LTE uplink channel to the AP 104. Although the plurality of segments 302a-310a may be broadcast simultaneously to the STAs 106a-106d, each of the receiving STAs 106a-106d may transmit a different request 316 based on the particular segments missing or corrupted at the particular STA.

Accordingly, the AP 104 may receive the request 316 and regenerate and retransmit the missing or corrupted segments 306a and 308a during the off-peak timeframe. The sink device (e.g., the STAs 106a-106d) may receive the retransmitted segments 306a and 308a as received segments 306b and 308b during the off-peak timeframe.

As further shown in FIG. 3, in some implementations, based on a subscription level or a type of sink device, the source device (e.g., the AP 104 of FIG. 1) may transmit and one or more of the sink devices (e.g., the STAs 106a-106d of FIG. 1) may receive an enhancement layer transmission (e.g., comprising a plurality of transmitted segments 352a, 354a, 356a, 358a, 360a received by the particular STA as received segments 352b, 354b, 356b, 358b, 360b). Each of the segments 352a, 354a, 356a, 358a, 360a may comprise the serial number 312 and data portions 314 as previously described in connection with packets 302a-310a. The enhancement layer segments 352a-360a may include additional data for providing the multimedia data transmission at a higher quality level than segments 302a-310a (e.g., high definition versus standard definition). In some implementations, the enhancement layer may be transmitted in substantially the same timeframe as the packets 302a-310a. In some other implementations, the enhancement layer may be transmitted during the off-peak timeframe or some other timeframe. In some implementations, the enhancement layer packets 352a-360a may include only additional data that may be utilized to upconvert the data within the packets 302a-310a to the higher quality (e.g., higher definition) multimedia file. In some other implementations, the enhancement layer packets 352a-360a may include all data for the higher quality multimedia file.

FIG. 4 is an exemplary timeline 400 depicting a network data traffic level 410 associated with the communication device of FIG. 2, in accordance with one implementation. As shown in FIG. 4, the timeline 400 depicts the network data traffic level on the vertical axis and time on the horizontal axis. Thus, the network data traffic level 410 varies over time. At time 402, the plurality of segments 302a-310a (see FIG. 3) may be broadcasted to and received by the STAs 106a-106d via LTE utilizing eMBMS. The STAs 106a-106d may additionally transmit the request 316 (see FIG. 3) at time 402. As shown, the network data traffic is greater than a predetermined threshold 420, and thus on-peak, at the time 402. At time 404 and/or time 406, the network data traffic is less than the predetermined threshold 420. It is at either of times 404 or 406 that the source (e.g. the AP 104 of FIG. 1) may retransmit the missing or corrupted packets to one or more of the STAs 106a-106d.

In some implementations, the level of the threshold 420 may be predetermined based on the connection quality of the LTE connection. In some other implementations, the level of the threshold 420 or the timeframe during which the missing or corrupted packets are retransmitted may be predetermined based on a subscription level associated with the receiving sink device (e.g., the particular one of the STAs 106a-106d). For example, sink devices that have a first subscription level may receive retransmitted packets at timeframe 406, while sink devices that have a second subscription level higher than the first subscription level may receive retransmitted packets at an earlier timeframe 404. As shown, both timeframes 404 and 406 occur during off-peak times, where network data traffic is below the predetermined threshold 420. Thus, based on one or more factors (e.g., the subscription level or connection quality) the predetermined threshold 420 and the timeframe 404/406 may be different for different sink devices.

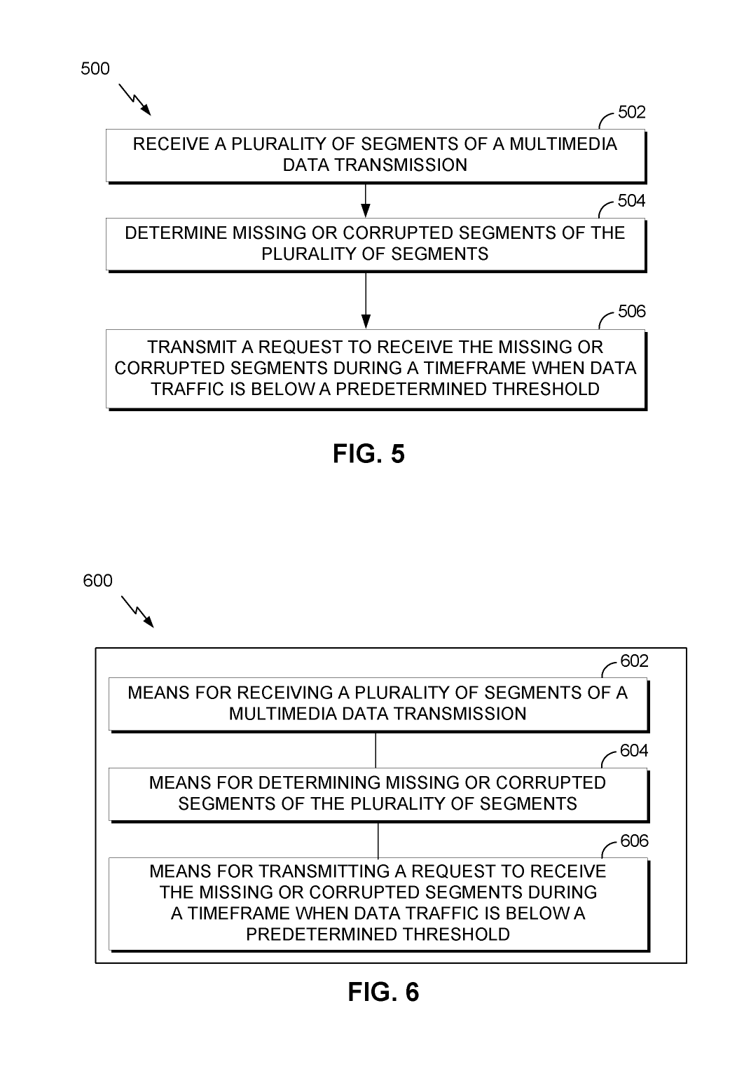

FIG. 5 is a flow chart 500 for a method of communication, in accordance with one implementation. In some implementations, one or more of the steps in flowchart 500 may be performed by, or in connection with, a processor, receiver and/or transmitter (e.g., the processor 204, receiver 212, and the transmitter 210 of FIG. 2) although those having ordinary skill in the art will appreciate that other components may be used to implement one or more of the steps described herein. Any of the STAs 106a-106d of FIG. 1 (as shown in more detail as the wireless device 202 of FIG. 2) may perform the method described below. Although blocks may be described as occurring in a certain order, the blocks can be reordered, blocks can be omitted, and/or additional blocks can be added.

The flowchart 500 may begin with block 502, which includes receiving a plurality of segments of a multimedia data transmission. For example, as shown in FIG. 3, with reference to FIG. 1, the AP 104 may transmit (e.g., broadcast) the plurality of segments 302a-310a (see FIG. 3) over an LTE cellular access network to one or more of the STAs 106a-106d (see FIG. 1). Thus, block 502 may be performed by the receiver 212 of the device 202 (see FIG. 2). The flowchart 500 may continue with block 504.

Block 504 may include determining missing or corrupted segments of the plurality of segments. For example, as previously described in connection with FIG. 3, any of the STAs 106a-106d may utilize the serial numbers (e.g., the serial numbers 312 in FIG. 3) within received packets or segments (e.g., within the segments 302a-310a in FIG. 3) of the multimedia data transmission to determine which if any packets are missing or have been received in a corrupted state. Block 504 may be performed by the processor 204 of the device 202 (see FIG. 2). The flowchart may continue with block 506.

Block 506 may include transmitting a request to receive the missing or corrupted segments during a timeframe when data traffic is below a predetermined threshold. For example, as previously described in connection with FIG. 3, any of the STAs 106a-106d (see FIG. 1) may transmit the request 316 to receive missing or corrupted segments during a timeframe (e.g., timeframes or instants 404 or 406 of FIG. 4) when data traffic is below the predetermined threshold 420 (see FIG. 4). The missing or corrupted packets (e.g., packets 306a and 308a) may then be transmitted to the requesting STA during the later timeframe.

FIG. 6 is a functional block diagram of an exemplary device for communicating, in accordance with one implementation. Those skilled in the art will appreciate that the device 600 may have more components than illustrated in FIG. 6. The device 600 includes only those components useful for describing some prominent features of implementations within the scope of the claims. In some implementations, the device 600 may be configured to perform the method(s) as previously described in flowchart 300 in FIG. 3. The device 600 may comprise either or both of the STAs 106a-106d shown in FIG. 1, for example, which may be shown in more detail as the device 202 shown in FIG. 2.

The device 600 comprises means 602 for receiving a plurality of segments of a multimedia data transmission. In some implementations, the means 602 can be configured to perform one or more of the functions described above with respect to block 302 of FIG. 3. The means 602 may comprise at least the receiver 212 and/or the processor 204 shown in FIG. 2, for example.

The device 600 may further include means 604 for determining missing or corrupted segments of the plurality of segments. The means 604 can be configured to perform one or more of the functions described above with respect to block 304 of FIG. 3. The means 604 may comprise at least the processor 204 shown in FIG. 2, for example. In some implementations, the means 604 may additionally comprise the memory 206 shown in FIG. 2, for example.

The device 600 may further include means 606 for transmitting a request to receive the missing or corrupted segments during a timeframe when data traffic is below a predetermined threshold. In some implementations, the means 606 can be configured to perform one or more of the functions described above with respect to block 306 of FIG. 3. The means 606 may comprise at least the processor 204 and/or the transmitter 210 shown in FIG. 2, for example. In some implementations, the means 606 may additionally comprise the memory 204 shown in FIG. 2, for example.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

1. An apparatus for wireless communication, comprising:
a receiver configured to receive a plurality of segments of a multimedia data transmission;
a processor configured to determine missing or corrupted segments of the plurality of segments; and
a transmitter configured to transmit a request to receive the missing or corrupted segments during a timeframe when data traffic is below a predetermined threshold.

2. The apparatus of claim 1, wherein each of the plurality of segments is encoded with a serial number and the processor is configured to determine the missing or corrupted segments based at least in part on the serial number of one or more of the plurality of segments.

3. The apparatus of claim 1, wherein the transmitter is configured to transmit the request via a wireless uplink (UL) channel.

4. The apparatus of claim 1, wherein the plurality of segments are received via a wireless broadcast.

5. The apparatus of claim 1, wherein the receiver is configured to receive an enhancement layer transmission providing multimedia data having a higher quality than a quality of the plurality of segments.

6. The apparatus of claim 1, wherein the length of at least one of the plurality of received segments is different from at least one other of the plurality of received segments in order to optimize an overhead requirement for the multimedia data transmission.

7. The apparatus of claim 1, wherein the timeframe is an off-peak timeframe.

8. The apparatus of claim 1, wherein at least one of the timeframe and the predetermined threshold are determined based on a subscription level associated with the apparatus.

9. A method for wireless communication, comprising:
receiving a plurality of segments of a multimedia data transmission;
determining missing or corrupted segments of the plurality of segments; and
transmitting a request to receive the missing or corrupted segments during a timeframe when data traffic is below a predetermined threshold.

10. The method of claim 9, wherein each of the plurality of segments is encoded with a serial number, the method further comprising determining the missing or corrupted segments based at least in part on the serial number of one or more of the plurality of segments.

11. The method of claim 9, comprising transmitting the request via a wireless uplink (UL) channel.

12. The method of claim 9, comprising receiving the plurality of segments via a wireless broadcast.

13. The method of claim 9, comprising receiving an enhancement layer transmission providing multimedia data having a higher quality than a quality of the plurality of segments.

14. The method of claim 9, wherein the length of at least one of the plurality of received segments is different from at least one other of the plurality of received segments in order to optimize an overhead requirement for the multimedia data transmission.

15. The method of claim 9, wherein the timeframe is an off-peak timeframe.

16. The method of claim 9, comprising determining at least one of the timeframe and the predetermined threshold based on a subscription level.

17. An apparatus for wireless communication, comprising:
means for receiving a plurality of segments of a multimedia data transmission;
means for determining missing or corrupted segments of the plurality of segments; and
means for transmitting a request to receive the missing or corrupted segments during a timeframe when data traffic is below a predetermined threshold.

18. The apparatus of claim 17, comprising means for encoding each of the plurality of segments with a serial number, wherein the means for determining the missing or corrupted segments is configured to determine the missing or corrupted segments based at least in part on the serial number of one or more of the plurality of segments.

19. The apparatus of claim 17, wherein the means for transmitting is configured to transmit the request via a wireless uplink (UL) channel.

20. The apparatus of claim 17, wherein the means for receiving is configured to receive the plurality of segments via a wireless broadcast.

21. The apparatus of claim 17, comprising means for receiving an enhancement layer transmission providing multimedia data having a higher quality than a quality of the plurality of segments.

22. The apparatus of claim 17, wherein the length of at least one of the plurality of received segments is different from at least one other of the plurality of received segments in order to optimize an overhead requirement for the multimedia data transmission.

23. The apparatus of claim 17, comprising means for determining at least one of the timeframe and the predetermined threshold based on a subscription level associated with the apparatus.

24. A non-transient computer-readable medium comprising code that, when executed, causes a device to:
receive a plurality of segments of a multimedia data transmission;
determine missing or corrupted segments of the plurality of segments; and
transmit a request to receive the missing or corrupted segments during a timeframe when data traffic is below a predetermined threshold.

25. The non-transitory computer-readable medium of claim 24, wherein each of the plurality of segments is encoded with a serial number, the code, when executed, further causing the device to determine the missing or corrupted segments based at least in part on the serial number of one or more of the plurality of segments.

26. The non-transitory computer-readable medium of claim 24, wherein the code, when executed, causes the device to transmit the request via a wireless uplink (UL) channel.

27. The non-transitory computer-readable medium of claim 24, wherein the code, when executed, causes the device to receive the plurality of segments via a wireless broadcast.

28. The non-transitory computer-readable medium of claim 24, wherein the code, when executed, causes the device to receive an enhancement layer transmission providing multimedia data having a higher quality than a quality of the plurality of segments.

29. The non-transitory computer-readable medium of claim 24, wherein the length of at least one of the plurality of received segments is different from at least one other of the plurality of received segments in order to optimize an overhead requirement for the multimedia data transmission.

30. The non-transitory computer-readable medium of claim 24, wherein the code, when executed, causes the device to determine at least one of the timeframe and the predetermined threshold based on a subscription level.
